(19) United States
(12) Patent Application Publication
(10) Pub. No.: US 2020/0156680 A1
(43) Pub. Date: May 21, 2020

(54) RAILWAY VEHICLE MAJOR COMPONENT AND SYSTEM DIAGNOSIS APPARATUS

(71) Applicants: GLOBIZ CO., LTD., Seoul (KR); Korea Railroad Corporation, Daejeon (KR)

(72) Inventors: JONG SOON IM, Seoul (KR); Jung Moo Yang, Daejeon (KR)

(73) Assignees: GLOBIZ CO., LTD., Seoul (KR); Korea Railroad Corporation, Daejeon (KR)

(21) Appl. No.: 16/688,272

(22) Filed: Nov. 19, 2019

(30) Foreign Application Priority Data
Nov. 19, 2018 (KR) 10-2018-0142750

(51) Int. Cl. B61L 27/00; G06F 16/25; G06F 16/22; G06F 16/28

(52) U.S. Cl. CPC B61L 27/0094; G06F 16/252; B61L 25/021; G06F 16/285; G06F 16/2264

(57) ABSTRACT

Disclosed is a railway vehicle major component and system diagnosis apparatus, which includes: a railway vehicle state summarizer that generates a feature value for at least one major component and system of a railway vehicle by summarizing sensing values collected through a plurality of sensors for a first period as a multi-dimensional railway vehicle parameter; a database generator that generates a database for at least one major component and system of a railway vehicle by normally distributing a plurality of feature values accumulated for a second period composed of a plurality of continuous first periods; and a railway vehicle diagnosis performer that detects and precisely diagnose abnormal situations in at least one major component and system of a railway vehicle on the basis of the database for major components and systems.

### CROSS-REFERENCE TO RELATED APPLICATION

This application claims priority to and the benefit of Korean Patent Application No. 10-2018-0142750 filed on Nov. 19, 2018, which is hereby incorporate by reference in its entirety.

### BACKGROUND

The present disclosure relates to a railway vehicle major component and system diagnosis apparatus and, more particularly, to an apparatus for diagnosing major components and systems of a railway vehicle, the apparatus being able to diagnose defects of major components and systems using sensing values collected from a plurality of sensors.

A high-speed railroad is a large-scale transportation system, and when an accident occurs, there is every possibility that the accident results in a large accident, so there is a need for a system that can detect a defect of a railway vehicle in early stages. Periodical maintenance is changing to Condition Based Maintenance (CBM) all over the world to reduce the costs for preventing accidents and for maintenance. Further, an on-time arrival ratio of a high-speed railroad is a very important factor in terms of public convenience and it is necessary to diagnose the states of the main parts and the system of railway vehicles in order to effectively maintain the on-time arrival ratio,

Korean Patent No. 10-0540162 (2005 Dec. 23) relates to an informatization system for maintaining railway vehicles. According to this system, work processes and data management that are separately distributed by operational organizations of railway vehicles can be integrally managed and operated by constructing informatization infrastructures, so the operational efficiency of the railroad can be increased. Further, it is possible to improve productivity and competitiveness by standardizing/informatizing the operation/maintenance system in the railway vehicle field.

Korean Patent No. 10-1231836 (2013 Feb. 4) relates to a real-time monitoring system for maintaining the doors of a railway vehicle. According to this system, when a door of a railway vehicle fails, it is possible to check state information such as controlling and monitoring histories of the door from state information of a DCU that controls the door by directly connecting a mobile computer such as notebook or an industrial computer, which can be carried, using a cable. Further, when a failure is generated, it is easy to analyze the reason of the failure, whereby it is possible to reduce the maintenance equipment and the maintenance time.

### PRIOR ART DOCUMENT

### Patent Document

Korean Patent No. 10-0540162 (2005 Dec. 23)

Korean Patent No. 10-1231836 (2013 Feb. 4)

### SUMMARY

An embodiment of the present disclosure provides a railway vehicle major component and system diagnosis apparatus, the apparatus being able to diagnose defects of major components and systems using various sensing values collected from a plurality of sensors.

An embodiment of the present disclosure provides a railway vehicle major component and system diagnosis apparatus, the apparatus being able to effectively detect abnormal situations in major components and systems by summarizing sensing values as a multi-dimensional railway vehicle parameter by grading the sensing values in accordance with level sections respectively determined in advance for a plurality of sensors.

An embodiment of the present disclosure provides a railway vehicle major component and system diagnosis apparatus, the apparatus being able to effectively detect abnormal situations in major components and systems by calculating distribution in a 2D coordinate system by classifying each of a plurality of feature values accumulated through sampling into one of a plurality of class levels.

In embodiments, a railway vehicle major component and system diagnosis apparatus includes: a railway vehicle state summarizer that generates a feature value for at least one major component and system of a railway vehicle by summarizing sensing values collected through a plurality of sensors for a first period as a multi-dimensional railway vehicle parameter; a database generator that generates a database for at least one major component and system of a railway vehicle by normally distributing a plurality of feature values accumulated for a second period composed of a plurality of continuous first periods; and a railway vehicle diagnosis performer that detects and precisely diagnose abnormal situations in at least one major component and system of a railway vehicle on the basis of the database for major components and systems.

The railway vehicle state summarizer may determine the first period to include sensing values for all of the plurality of sensors on the basis of a sensing cycle of each of the plurality of sensors.

The railway vehicle state summarizer may grade sensing values in accordance with level sections defined in advance for the plurality of sensors and then summarize the sensing values as the multi-dimensional railway vehicle parameter.

The database generator may calculate distribution in a 2D coordinate system for feature values and class levels by classifying each of the plurality of feature values into one of a plurality of class levels.

The database generator may sequentially classify multi-dimensional railway vehicle parameters of the plurality of feature values in accordance with a classification order, thereby finally classifying the feature values into one of a plurality of class levels.

The railway vehicle diagnosis performer may determine a normal range by applying detection references defined step by step respectively for the at least one major component and system of a railway vehicle.

The railway vehicle diagnosis performer may perform real-time sampling with intervals of the first period for the at least one major component and system of a railway vehicle, and when a feature value generated through the sampling is out of the normal range and is continuously repeated by a reference number of times, the railway vehicle diagnosis performer may detect it as an abnormal situation.

The railway vehicle diagnosis performer may perform real-time sampling with intervals shorter then the interval of the first period for major components and systems of a railway vehicle from which the abnormal situation has been detected, and may perform precise diagnosis on the basis of feature values generated through the sampling.

### BRIEF DESCRIPTION OF THE DRAWINGS

FIG. 1 is a diagram illustrating a railway vehicle major component and system diagnosis system according to an embodiment of the present disclosure.

FIG. 2 is a block diagram illustrating the railway vehicle major component and system diagnosis apparatus shown in FIG. 1.

FIG. 3 is a flowchart illustrating a railway vehicle major component and system diagnosis process that is performed in the railway vehicle major component and system diagnosis apparatus shown in FIG. 1.

FIGS. 4 to 6 are exemplary diagrams illustrating a process of determining a class level for major components and systems using multi-dimensional railway vehicle parameters in the railway vehicle major component and system diagnosis apparatus shown in FIG. 1.

FIGS. 7 and 8 are exemplary diagrams illustrating a process of calculating 2D distribution of feature values for major components and systems in the railway vehicle major component and system diagnosis apparatus shown in FIG. 1.

### DETAILED DESCRIPTION

The description in the present disclosure is only embodiments for structural and functional description, so the scope of a right of the present disclosure should not be construed as being limited by the embodiments described herein. That is, embodiments may be changed and modified in various ways, so the scope of a right of the present disclosure should be understood as including equivalents that can achieve the spirit of the present disclosure. Further, the objects or effects proposed herein do not mean that the objects or effects should be all included in a specific embodiment or only the effects should be included in a specific embodiment, so the scope of a right of the present disclosure should not be construed as being limited by the objects or effects.

Meanwhile, terms used herein should be understood as follows.

Terms “first”, “second”, etc. are provided for discriminating one component from another component and the scope of a right is not limited to the terms. For example, the first component may be named the second component, and vice versa.

It is to be understood that when one element is referred to as being “connected to” another element, it may be connected directly to another element or be connected to another element, having the other element intervening therebetween. On the other hand, it is to be understood that when one element is referred to as being “connected directly to” another element, it may be connected to or coupled to another element without the other element intervening therebetween. Meanwhile, the terms used herein to describe a relationship between elements, that is, “between”, “directly between”, “adjacent” or “directly adjacent” should be interpreted in the same manner as those described above.

Singular forms should be understood as including plural forms unless the context clearly indicates otherwise, and it will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

In each step, reference characters (e.g., a, b, and c) are used for convenience without determining the order of each step, and each step may occur different from the orders described herein unless specific orders are clearly described in contexts. That is, each step may occur in the order described herein, may be substantially simultaneously performed, or may be performed in a reverse order.

The present disclosure may be achieved as computer-readable codes in a computer-readable recording medium and the computer-readable recording medium includes all kinds of recording devices in which data that can be read out by a computer system are stored. The computer-readable recording medium, for example, may be a ROM, a RAM, a CD-ROM, a magnetic tape, a floppy disk, an optical data storage device, etc. Further, the computer-readable recording media may be distributed to computer systems that are connected through a network and may store and execute computer-readable codes in the type of distribution.

Unless otherwise defined, all terms used herein have the same meaning as commonly understood by those skilled in the art to which the present disclosure belongs. It will be further understood that terms defined in dictionaries that are commonly used should be interpreted as having meanings that are consistent with their meanings in the context of the relevant art and will not be interpreted in an idealized or overly formal sense unless expressly so defined herein.

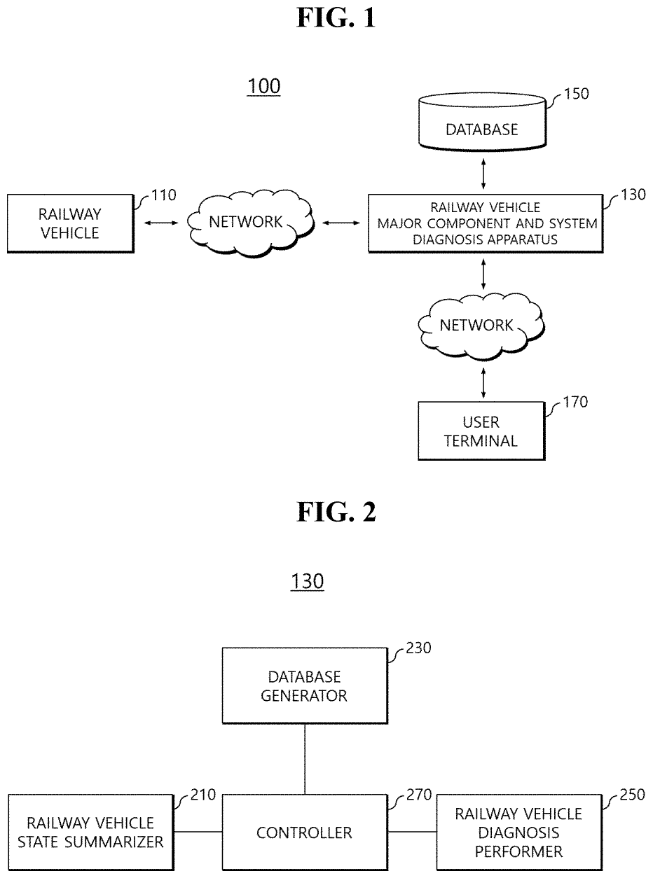

FIG. 1 is a diagram illustrating a railway vehicle major component and system diagnosis system according to an embodiment of the present disclosure.

Referring to FIG. 1, a railway vehicle major component and system diagnosis system 100 may include a railway vehicle 110, a railway vehicle major component and system diagnosis apparatus 130, a database 150, and a user terminal 170.

The railway vehicle 110 may correspond to a power-driven vehicle, a passenger vehicle, a freight vehicle, a special vehicle, etc. that are manufactured to be driven on railroads. In an embodiment, the railway vehicle 110 may include a plurality of sensors that can measure relevant data to monitor the states of various components. For example, the railway vehicle 110 may include a hunting sensor, a vibration sensor, an acceleration sensor, a Global Positioning System (GPS) sensor, a current sensor, a thermal imaging sensor, a wheel sensor, a driving sensor, etc.

The railway vehicle major component and system diagnosis apparatus 130 may be implemented as a server corresponding to a computer or a program that can diagnose in advance defects of major components and systems constituting the railway vehicle 110. The major components and systems described herein may correspond to components that may influence the safety of the railway vehicle 110 and passengers when a defect is generated in the components constituting the railway vehicle 110. The railway vehicle major component and system diagnosis apparatus 130 can be wirelessly connected with the railway vehicle 110 through Bluetooth, Wi-Fi, etc., and can exchange data with the railway vehicle 110 through a network.

In an embodiment, the railway vehicle major component and system diagnosis apparatus 130 can receive sensing values periodically or in real time from a plurality of sensors included in the railway vehicle 110, and can diagnose abnormal situations or defects of major components and systems and provide the result to the railway vehicle 110. In another embodiment, the railway vehicle major component and system diagnosis apparatus 130 may be included in the railway vehicle 110 and can provide a diagnosis result for major components and systems to the user terminal 170.

In an embodiment, the railway vehicle major component and system diagnosis apparatus 130 can store information for diagnosing major components and systems in cooperation with the database 150. Meanwhile, the railway vehicle major component and system diagnosis apparatus 130, unlike FIG. 1, may include the database 150. Further, the railway vehicle major component and system diagnosis apparatus 130 may include a processor, a memory, a user I/O device, and a network I/O device.

The database 150 is a storage device that can store various items of information for diagnosis major components and systems of a railway vehicle. The database 150 can store information about the railway vehicle 110 and various major components and systems constituting the railway vehicle 110 and can store a plurality of sensing values received from the railway vehicle 110. However, the database 150 is not necessarily limited thereto and may store information collected and processed in various types in the process of diagnosing major components and systems of a railway vehicle on the basis of a plurality of sensing values.

The user terminal 170 may correspond to a computing device that can receive results of diagnosing major components and systems performed by the railway vehicle major component and system diagnosis apparatus 130 and can display the results through various interfaces. The user terminal 170 may be a smartphone, a notebook, or a computer, but is not limited thereto and may be various devices such as a tablet PC. The user terminal 170 may be connected with the railway vehicle major component and system diagnosis apparatus 130 through a network and a plurality of user terminals 170 may be all connected with the railway vehicle major component and system diagnosis apparatus 130. In an embodiment, the user terminal 170 may be registered in advance on the railway vehicle 110 and/or the railway vehicle major component and system diagnosis apparatus 130.

FIG. 2 is a block diagram illustrating the railway vehicle major component and system diagnosis apparatus shown in FIG. 1.

Referring to FIG. 2, the railway vehicle major component and system diagnosis apparatus 130 may include a railway vehicle state summarizer 210, a database generator 230, a railway vehicle diagnosis performer 250, and a controller 270.

The railway vehicle state summarizer 210 can generate a feature value for at least one major component and system of a railway vehicle by summarizing sensing values collected through a plurality of sensors for a first period as a multi-dimensional railway vehicle parameter. The first period, which is a time period defined in advance, may correspond to a unit time period for collecting sensing values from a plurality of sensors provided to find out the state of a railway vehicle. The feature value may correspond to a value showing the states of major components and systems constituting a railway vehicle, and for example, may correspond to a value showing states about overheating of a motor block, overheating of a distribution board, the water level in a condensate water tank, sticking of a door, a door defect, a tripod, a wheel bearing, wheel flatting, a gearbox, a truck instability, and a blower defect.

Further, the multi-dimensional railway vehicle parameter may correspond to a sensing value vector composed of only sensing values related to diagnosis of specific major components and systems of sensing values collected from a plurality of sensors. That is, the railway vehicle state summarizer 210 can generate a feature value by selecting sensing values respectively for major components and systems of a railway vehicle on the basis of sensing values collected from a plurality of sensors, and then summarizing the selected sensing values as a multi-dimensional railway vehicle parameter.

For example, the railway vehicle state summarizer 210 can define and use feature values and multi-dimensional railway vehicle parameters about the following diagnosis items for major components and systems of a railway vehicle (diagnosis item: feature value (multi-dimensional railway vehicle parameter)).

1) Overheating of motor block: Temperature of motor block (Speed, Power, GPS)

2) Overheating of distribution board: Temperature of distribution board (Speed, Power, GPS)

3) Flooding of condensate water: Level of condensate water (Level of condensate water)

4) Sticking of door: Door gap (Door gap)

5) Door defect: Operation current (Door opening/closing hysteresis)

6) Tripod defect: Torsional angle of shaft (Speed, Power, GPS)

7) Wheel bearing defect: Wheel vibration (Speed, Power, GPS)

8) Wheel abrasion: Wheel vibration (Speed, Power, GPS)

9) Gearbox defect: Gearbox vibration (Speed, Power, GPS)

10) Truck instability: Truck vibration (Speed, Power, GPS)

11) Blower defect: Blower vibration (Speed, Power, GPS)

In an embodiment, the railway vehicle state summarizer 210 can determine a first period to include sensing values for all of a plurality of sensors on the basis of the sensing cycle of each of the plurality of sensors. The railway vehicle state summarizer 210 can designate time that is long enough to include all the sensing cycles of sensors to be able to collect at least one sensing value from all of a plurality of sensors for the first period. For example, when there are three sensors and the sensing cycles of the sensors are 1 seconds, three seconds, and five seconds, respectively, the railway vehicle state summarizer 210 can collect at least one sensing value from all of the three sensors for the first period by determining the first period as at least 5 seconds or more.

In an embodiment, the railway vehicle state summarizer 210 can grade sensing values in accordance with level sections defined in advance for a plurality of sensors and then summarize the sensing values as a multi-dimensional railway vehicle parameter. For example, when actual sensing values collected through a speed sensor, a power sensor, and a temperature sensor are 55 km, 33%, and 15°, respectively, the railway vehicle state summarizer 210 can grade the speed 55 km into a second level of speed, the power 33% into a fourth level of power, and the temperature 15° into a fourth level of temperature in accordance with the level sections defined for sensors. As a result, when (speed, power, temperature)=(55 km, 33%, 15°), the railway vehicle state summarizer 210 can summarize (speed, power, temperature)=(55 km, 33%, 15°) as a multi-dimensional railway vehicle parameter through grading.

The database generator 230 can generate a database for at least one major component and system of a railway vehicle by normally distributing a plurality of feature values accumulated for a second period composed of a plurality of continuous first periods. The database generator 230 can generate a database for major components and systems of a railway vehicle by accumulating feature values that are generated for the first periods, respectively. The second period may correspond a time period defined by a plurality of continuous first periods. As a result, the database generator 240 can reduce the calculation and time needed for constructing a database by generating a database using only information summarized for each period in accordance with a sampling cycle for the second period rather than generating a database on the basis of all sensing values collected for the second period.

Further, the database generator 230 can secure continuous data for the entire second time by performing normal distribution on the basis of feature values accumulated for the second time, which can provide an effect that it is possible to effectively reduce the calculation and time needed for constructing a database about at least one major component and system of a railway vehicle.

In an embodiment, the database generator 230 can calculate distribution in a 2D coordinate system for feature values and class levels by classifying each of a plurality of feature values into one of a plurality of class levels. The database generator 230 can classify feature values summarized as a multi-dimensional railway vehicle parameter into one of a plurality of class levels defined in advance, and can calculate distribution of feature values by showing the feature values in a 2D coordinate system having a class level on an x-axis and a feature value on a y-axis. The class level may be a classification item defined for classifying feature values and the number of the class levels may be calculated on the basis of the order number of multi-dimensional railway vehicle parameters and the level number of the parameters.

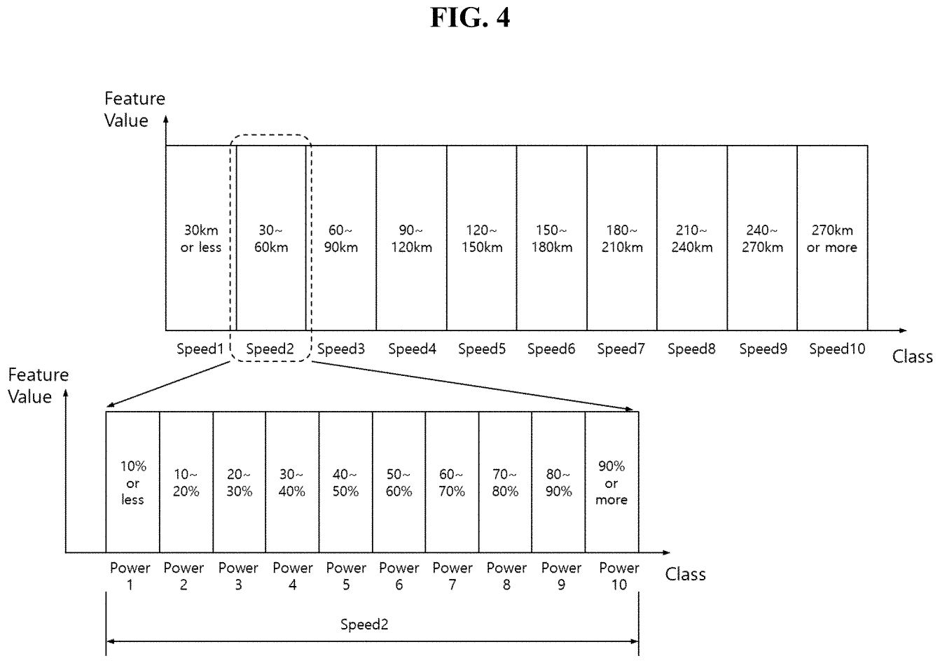

In an embodiment, the database generator 230 sequentially classifies multi-dimensional railway vehicle parameters of a plurality of feature values in accordance with a classification order, thereby being able to finally classify them into one of a plurality of class levels. The class level classification method that is performed by the database generator 230 is described in more detail with reference to FIGS. 4 to 6.

The railway vehicle diagnosis performer 250 can detect and precisely diagnose abnormal situations in at least one major component and system of a railway vehicle on the basis of a database for major components and systems. It is possible to estimate or detect abnormal situations in major components and systems of a railway vehicle on the basis of whether feature values, which are collected from a plurality of sensors and generated by the railway vehicle state summarizer 210, are values in a normal range on the basis of a database for major components and systems generated by the database generator 230, and it is possible to precisely diagnose major components and systems of railway vehicle in which an abnormal situation has been estimated or detected.

In an embodiment, the railway vehicle diagnosis performer 250 can determine the normal range by applying detection references defined step by step respectively for at least one major component and system of a railway vehicle. The railway vehicle diagnosis performer 250 can determine the range of feature values that are collected in a normal operation process for each major component and system of a railway vehicle on the basis of the database for major components and systems. The detection references may correspond to references that enable determining whether the operations of specific major components and system are abnormal through comparison with information stored in a database, and for example, may include a warning and an alarm. The warning is a reference for determining a situation in which possibility that abnormality occurs in major components and systems, and the alarm is a higher level than the warning and may correspond to a reference for determining a situation in which immediate diagnosis or examination is required.

Further, the railway vehicle diagnosis performer 250 can define and use a normal range according to detection references for diagnosis items of major components and systems of a railway vehicle as follows.

1) Overheating of motor block

Criterion setting: Tmref (Speed, Power, GPS)=Tmpeak (Speed, Power, GPS)*Fm(=1.5, 2.0: Warning, Alarm) in Motor block temperature (Speed, Power, GPS) at VML<Speed<VMH, PML(Speed)<Power<PMH(Speed), and Class(GPS)

2) Overheating of distribution board

Criterion setting: Tdref(Speed, Power, GPS)=Tdpeak(RMP, Speed, GPS)*Fd(=1.5, 2.0: Warning, Alarm) in Distribution board temperature(Speed, Power, GPS) at VDL<Speed<VDH, PDL(Speed)<Speed<PDH(RPM), and Class(GPS)

3) Flooding of condensate water

Criterion setting: Htref=Htpeak*Fh(=1.1, 1.2: Warning, Alarm)

4) Sticking of door

Criterion setting: Gpref=Gppeak*Fg(=1.1, 1.2: Warning, Alarm)

5) Door defect

Criterion setting: Ghref=Ghpeak*Ft(=1.1, 1.2: Warning, Alarm)

6) Tripod defect

Primary Criterion setting: Tref (Speed, Power, GPS)=Trms (Speed, Power, GPS)*Ft(=1.5, 2.0: Warning, Alarm) in Torsional angle of shaft(Speed, Power, GPS) at VTL<Speed<VTH, and PTL(Speed)<Power<PTH(Speed), and Class(GPS)

Secondary Criterion setting: Stref-tdfi (Speed, Power, GPS)=Stpeak-tdfi (Speed, Power, GPS)*Ft(=1.5, 2.0: Warning, Alarm) in Torsional vibration Enveloping Spectrum or Kepstrum (Speed, Power, GPS), Tripod defect frequency(tdfi) at VTL<Speed<VTH, and PTL(Speed)<Power<PTH(Speed), and Class(GPS)

7) Wheel bearing defect

Primary Criterion setting: Wref(Speed, Power, GPS)=Wrms((Speed, Power, GPS)*Fw(=1.5, 2.0: Warning, Alarm) in Wheel vibration (Speed, Power, GPS) at VWL<Speed<VWH, and PWL(Speed)<Power<PWH(Speed), and Class(GPS)

Secondary Criterion setting: Swref-wdfi (Speed, Power, GPS)=Swpeak-wdfi(Speed, Power, GPS)*Fw(=1.5, 2.0: Warning, Alarm) in Wheel vibration Enveloping Spectrum(Speed, Power, GPS), Wheel bearing defect frequency(wdfi) at VWL<Speed<VWH, and PWL(Speed)<Power<PWH(Speed), and Class(GPS)

8) Wheel abrasion

Primary Criterion setting: Sref(Speed, Power, GPS)=Srms((Speed, Power, GPS)*Fw(=1.5, 2.0: Warning, Alarm) in Wheel vibration (Speed, Power, GPS) at VSL<Speed<VSH, and PSL(Speed)<Power<PSH(Speed), and Class(GPS)

Secondary Criterion setting: Ssref-sdfi(RMP, Speed, Acceleration pedal angle)=Sspeak-sdfi(RMP, Speed, Acceleration pedal angle)*Fs(=1.5, 2.0: Warning, Alarm) in Wheel vibration Power, ENVEOPING Spectrum, Kepstrum (Speed, Power, GPS), Wheel defect frequency(sdfi) at VSL<Speed<VSH, and PSL(Speed)<Power<PSH(Speed), and Class(GPS)

9) Gearbox defect

Primary Criterion setting: Gref(Speed, Power, GPS)=Grms(Speed, Power, GPS)*Fg(=1.5, 2.0: Warning, Alarm) in Knuckle vibration (Speed, Power, GPS) at VGL<Speed<VGH, and PGL(Speed)<Power<PGH(Speed), and Class(GPS)

Secondary Criterion setting: Sgref-gdfi (Speed, Power, GPS)=Sgpeak-gdfi (Speed, Power, GPS)*Fg(=1.5, 2.0: Warning, Alarm) in Gearbox vibration Enveloping Spectrum or Kepstrum (Speed, Power, GPS), Gear&Bearing defect frequency(gdfi) at VGL<Speed<VGH, and PGL(Speed)<Power<PGH(Speed), and Class(GPS)

10) Truck instability

Primary Criterion setting: Bref(Speed, Power, GPS)=Brms(Speed, Power, GPS)*Fb(=1.5, 2.0: Warning, Alarm) in Truck instability(Speed, Power, GPS) at VBL<Speed<VBH, and PBL(Speed)<Power<PBH(Speed), and Class(GPS)

Secondary Criterion setting: Sbref-bdfi (Speed, Power, GPS)=Sbpeak-bdfi(Speed, Power, GPS)*Fb(=1.5, 2.0: Warning, Alarm) in Truck instability Power Spectrum(Speed, Power, GPS), Truck instability natural frequency(bdfi) at VBL<Speed<VBH, and PBL(Speed)<Power<PBH(Speed), and Class(GPS)

11) Blower defect

Primary Criterion setting: Fref(Speed, Power, GPS)=Frms(Speed, Power, GPS)*Ff(=1.5, 2.0: Warning, Alarm) in Blower vibration(Speed, Power, GPS) at VFL<Speed<VFH, and PFL(Speed)<Power<PFH(Speed), and Class(GPS)

Secondary Criterion setting: Sfref-fdfi (Speed, Power, GPS)=Sfpeak-fdfi(Speed, Power, GPS)*Ff(=1.5, 2.0: Warning, Alarm) in Wheel vibration Power, ENVEOPING Spectrum or Kepstrum (Speed, Power, GPS), Nlower defect frequency(fdfi) at VFL<Speed<VFH, and PFL(Speed)<Power<PFH(Speed), and Class(GPS)

In an embodiment, the railway vehicle diagnosis performer 250 can perform real-time sampling with intervals of the first period for at least one major component and system of a railway vehicle, and when a feature value generated through the sampling is out of the normal range and is continuously repeated by a reference number of times, the railway vehicle diagnosis performer 250 can detect it as an abnormal situation. The reference number of times may be set in advance by the railway vehicle major component and system diagnosis apparatus 130, or may be automatically set. The railway vehicle diagnosis performer 250 can detect features values that are out of the normal range on the basis of a database for major components and systems, and when a feature value is repeatedly out of the normal range, the railway vehicle diagnosis performer 250 can estimate or diagnose that abnormality has be generated in major components and systems related to the feature value.

Further, the railway vehicle diagnosis performer 250 can define and use a diagnosis algorithm for diagnosis items of major components and systems of a railway vehicle as follows.

1) Overheating of motor block

Motor block temperature(Speed, Power, GPS)>Tmref(Speed, Power, GPS) & Repeat at VML<Speed<VMH, PML(Speed)<Power<PMH(Speed), and Class(GPS)

2) Overheating of distribution board

Distribution board temperature(Speed, Power, GPS)>Tdref(Speed, Power, GPS) & Repeat at VDL<Speed<VDH, PDL(Speed)<Power<PDH(Speed), and Class(GPS)

3) Flooding of condensate water

Level of condensate water>Htref & Repeat

4) Sticking of door

Door gap>Gpref & Repeat

5) Door defect

Door opening/closing hysteresis>Ghref & Repeat

6) Tripod defect

Torsional angle of shaft(Speed, Power, GPS)>Tref (Speed, Power, GPS) & Repeat at VTL<Speed<VTH, and PTL(Speed)<Power<PTH(Speed), and Class(GPS)

7) Wheel bearing defect

Wheel vibration (Speed, Power, GPS)>Wref(Speed, Power, GPS) & Repeat at VWL<Speed<VWH, and PWL(Speed)<Power<PWH(Speed), and Class(GPS)

8) Wheel abrasion

Wheel vibration (Speed, Power, GPS)>Sref(Speed, Power, GPS) & Repeat at VSL<Speed<VSH, and PSL(Speed)<Power<PSH(Speed), and Class(GPS)

9) Gearbox defect

Gearbox vibration(Speed, Power, GPS)>Gref(Speed, Power, GPS) & Repeat at VGL<Speed<VGH, and PGL(Speed)<Power<PGH(Speed), and Class(GPS)

10) Truck instability

Truck vibration(Speed, Power, GPS)>Bref(Speed, Power, GPS) & Repeat at VBL<Speed<VBH, and PBL(Speed)<Power<PBH(Speed), and Class(GPS)

11) Blower defect

: Blower vibration(Speed, Power, GPS)>Frms(Speed, Power, GPS) & Repeat at VFL<Speed<VFH, and PFL(Speed)<Power<PFH(Speed), and Class(GPS)

In an embodiment, the railway vehicle diagnosis performer 250 can perform real-time sampling with intervals shorter then the interval of the first period for major components and systems of a railway vehicle from which an abnormal situation has been detected, and can perform precise diagnosis on the basis of feature values generated through the sampling. The railway vehicle diagnosis performer 250 can classify in advance major components and systems that have been diagnosed through primary diagnosis, and major components and systems that require secondary diagnosis after the primary diagnosis, and can use these major components and systems for railway vehicle diagnosis. The railway vehicle diagnosis performer 250 can determine whether secondary diagnosis is required for major components and systems of a railway vehicle from which an abnormal situation has been detected, and when the major components and systems correspond to pre-defined major components and systems that require secondary diagnosis, the railway vehicle diagnosis performer 250 can perform precise diagnosis on the basis of feature values sampled with intervals shorter than the interval of the first period.

That is, the railway vehicle diagnosis performer 250 can perform primary diagnosis through sampling with a high cycle and can perform secondary diagnosis through sampling with a low cycle, thereby being able to efficiency in diagnosis through step-by-step diagnosis. Further, the railway vehicle diagnosis performer 250 can define and use a precise diagnosis algorithm for diagnosis items of major components and systems of a railway vehicle as follows.

1) Tripod defect

Torsional vibration ENVEOPING Spectrum or Kepstrum(Speed, Power, GPS)>Stref-tdfi(Speed, Power, GPS) & Repeatness in Torsional vibration Enveloping Spectrum or Kepstrum(Speed, Power, GPS), Tripod defect frequency(tdfi) at VTL<Speed<VTH, and PTL(Speed)<Power<PTH(Speed), and Class(GPS)

2) Wheel bearing defect

Wheel vibration ENVEOPING Spectrum(Speed, Power, GPS)>Swref-wdfi(Speed, Power, GPS) & Repeatness in Wheel vibration Enveloping Spectrum(Speed, Power, GPS), Wheen defect frequency(wdfi) at VWL<Speed<VWH, and PWL(Speed)<Power<PWH(Speed), and Class(GPS)

3) Wheel abrasion

Wheel vibration Power, ENVEOPING Spectrum or Kepstrum(Speed, Power, GPS)>Ssref-sdfi(Speed, Power, GPS) & Repeatness in Wheel vibration Power, ENVEOPING Spectrum, Kepstrum(Speed, Power, GPS), Wheel defect frequency(sdfi) at VSL<Speed<VSH, and PSL(Speed)<Power<PSH(Speed), and Class(GPS)

4) Gearbox defect

Gearbox vibration ENVEOPING Spectrum or Kepstrum(Speed, Power, GPS)>Sgref(Speed, Power, GPS) & Repeatness in Gearbox vibration Enveloping Spectrum or Kepstrum(Speed, Power, GPS), Gear&Bearing defect frequency(gdfi) at VGL<Speed<VGH, and PGL(Speed)<Power<PGH(Speed), and Class(GPS)

5) Truck instability

Truck vibration Power Spectrum(Speed, Power, GPS)>Sbref-bdfi(Speed, Power, GPS) & Repeatness in Truck vibration Power Spectrum(Speed, Power, GPS), Truck vibration natural frequency(bdfi) at VBL<Speed<VBH, and PBL(Speed)<Power<PBH(Speed), and Class(GPS)

6) Blower defect

Blower vibration Power, ENVEOPING Spectrum, Kepstrum(Speed, Power, GPS)>Sfref-fdfi((Speed, Power, GPS) & Repeatness in Wheel vibration Power, ENVEOPING Spectrum, Kepstrum(Speed, Power, GPS), Blower defect frequency(fdfi) at VFL<Speed<VFH, and PFL(Speed)<Power<PFH(Speed), and Class(GPS)

In an embodiment, the railway vehicle diagnosis performer 250 performs sampling with intervals shorter than the interval of the first period for major components and systems of a railway vehicle from which an abnormal situation has been detected, and can generate feature values for precise diagnosis through any one of envelope analysis and Fast Fourier Transform (FFT) on the basis of sensing values collected through the sampling. The railway vehicle major component and system diagnosis apparatus 130 may set in advance which one of Envelope analysis and FFT it uses in accordance with major components and systems of a railway vehicle. Feature values generated by using envelope analysis or FFT may correspond to an enveloping spectrum, a power spectrum, and a cepstrum or kepstrum. envelope analysis or FFT is well known to those skilled in the art, so they are not described in detail.

For example, when a diagnosis item related to major components and systems of a railway vehicle is a tripod defect, the railway vehicle diagnosis performer 250 can calculate an enveloping spectrum by performing envelope analysis on sensing values for a multi-dimensional railway vehicle parameter related to torsional vibration. The railway vehicle diagnosis performer 250 can perform precise diagnosis using the enveloping spectrum as a feature value for the tripod defect. As for a wheel bearing defect, the railway vehicle diagnosis performer 250 can calculate an enveloping spectrum for wheel vibration and can perform precise diagnosis for the wheel bearing defect on the basis of the enveloping spectrum.

The controller 270 can control the entire operation of the railway vehicle major component and system diagnosis apparatus 130 and can manage control flow or data flow among the railway vehicle state summarizer 210, the database generator 230, and the railway vehicle diagnosis performer 250.

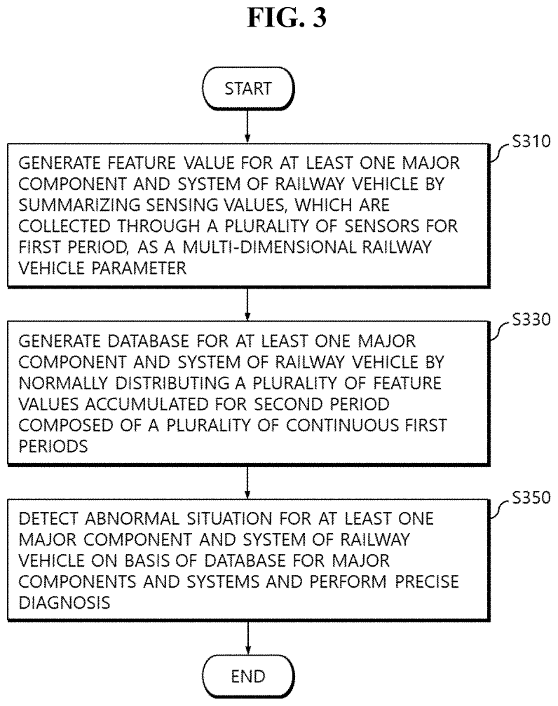

FIG. 3 is a flowchart illustrating a railway vehicle major component and system diagnosis process that is performed in the railway vehicle major component and system diagnosis apparatus shown in FIG. 1.

Referring to FIG. 3, the railway vehicle major component and system diagnosis apparatus 130 can generate a feature value for at least one major component and system of a railway vehicle by summarizing sensing values, which are collected through a plurality of sensors for the first period, as a multi-dimensional railway vehicle parameter through the railway vehicle state summarizer 210 (step S310).

The railway vehicle major component and system diagnosis apparatus 130 can generate a database for at least one major component and system of a railway vehicle by normally distributing a plurality of feature values accumulated for a second period composed of a plurality of continuous first periods through the database generator 230 (step S330).

The railway vehicle major component and system diagnosis apparatus 130 can detect an abnormal situation for at least one major component and system of a railway vehicle on the basis of a database for major components and systems and can perform precise diagnosis through the railway vehicle diagnosis performer 250 (step S350).

FIGS. 4 to 6 are exemplary diagrams illustrating a process of determining a class level for major components and systems using multi-dimensional railway vehicle parameters in the railway vehicle major component and system diagnosis apparatus shown in FIG. 1.

Referring to FIGS. 4 to 6, it is possible to see a process in which the railway vehicle major component and system diagnosis apparatus 130 classifies feature values for major components and systems of a railway vehicle into class levels using multi-dimensional railway vehicle parameters. In more detail, the multi-dimensional railway vehicle parameters constituting feature values of major components and systems may be expressed to include a speed, power, a railroad, and temperature, in which the speed and power each may be graded into levels of ten steps (or levels), and the railroad and temperature each may be graded into levels of five steps.

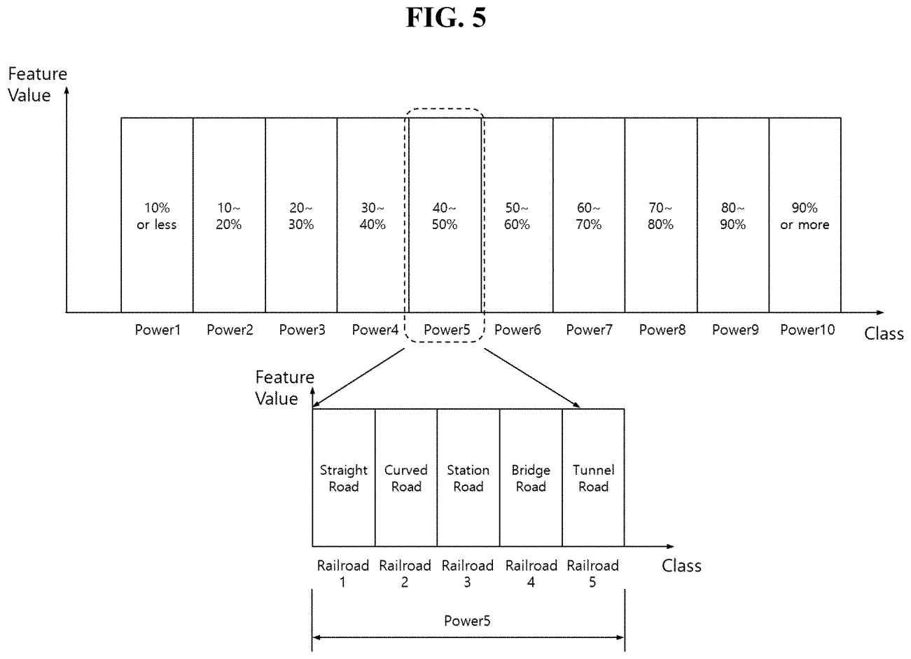

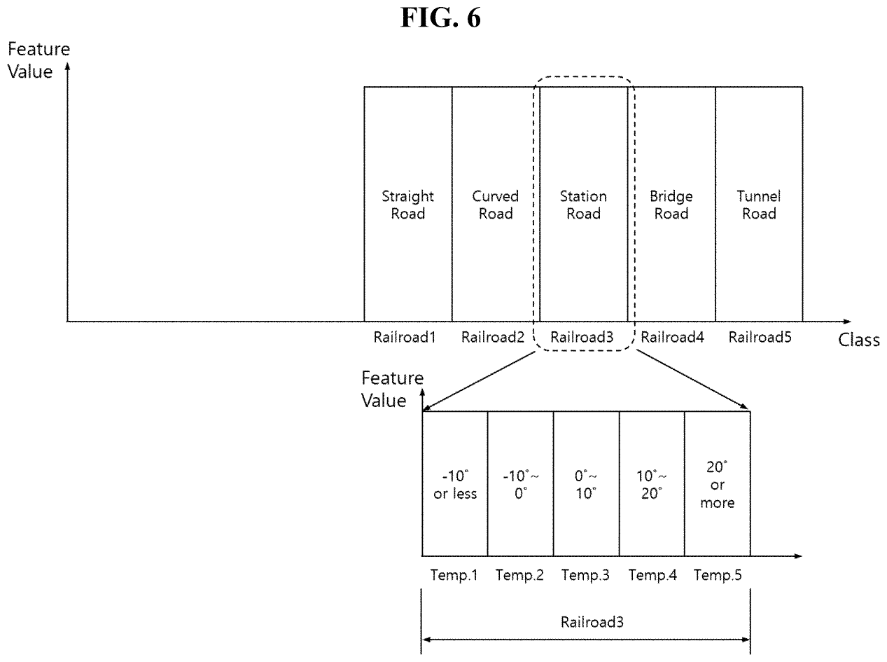

For example, when multi-dimensional railway vehicle parameters constituting a feature value are speed=2, power=5, railroad=3, and temperature=4, it is possible to divide the period of step of speed 2 into ten steps of power in FIG. 4, the period of step of power 5 into five steps of railroad in FIG. 5, and the period of step of railroad 3 into five steps of temperature in FIG. 6. The railway vehicle major component and system diagnosis apparatus 130 can finally determine the class level corresponding to the step of power 4 as a final class level.

The railway vehicle major component and system diagnosis apparatus 130 can effectively classify class levels for feature values using graded multi-dimensional railway vehicle parameters, and can effectively construct a database for each of major components and systems of a railway vehicle on the basis of the class levels, and can use the database to diagnose the major components and systems.

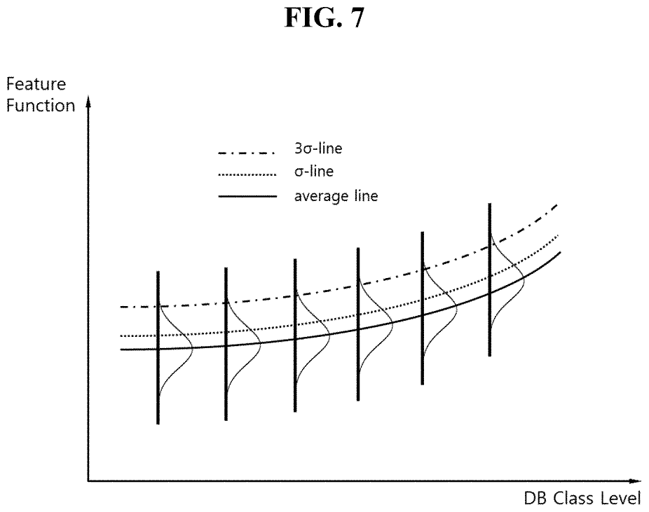

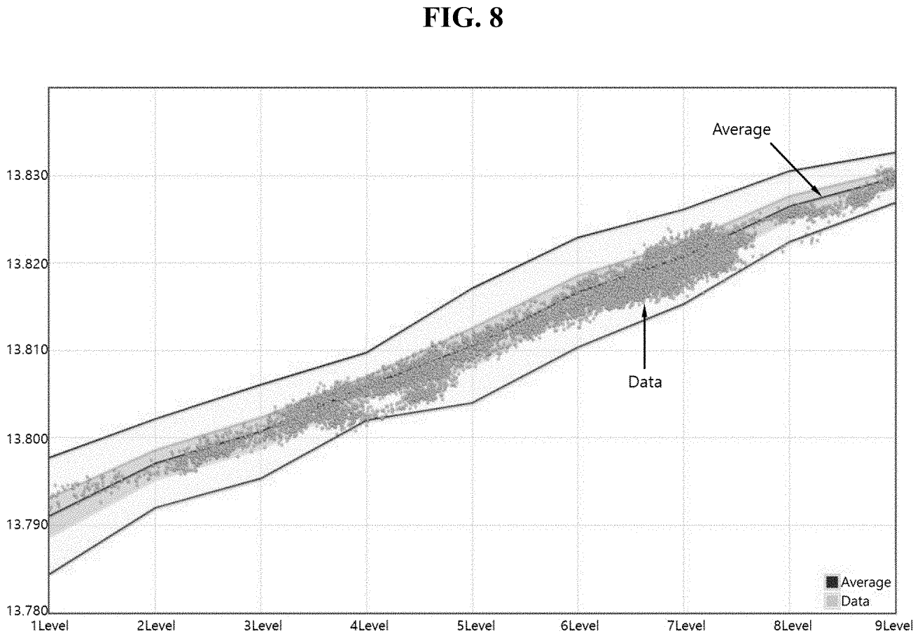

FIGS. 7 and 8 are exemplary diagrams illustrating a process of calculating 2D distribution of feature values for major components and systems in the railway vehicle major component and system diagnosis apparatus shown in FIG. 1.

In FIG. 7, the railway vehicle major component and system diagnosis apparatus 130 can show feature values generated by the railway vehicle state summarizer 210 in a 2D coordinate system. The railway vehicle major component and system diagnosis apparatus 130 can generate a 2D graph by setting a feature value on a y-axis and a DB class level corresponding to the feature value on an x-axis.

The feature value may include a speed, power, a railroad, and temperature as multi-dimensional railway vehicle parameters, in which the speed and power each may be configured in ten steps (or levels), and the railroad and temperature each may be configured in five steps. The railway vehicle major component and system diagnosis apparatus 130 can calculate the total steps (or levels) of the DB class level corresponding to the x-axis through product of the number of steps of each of parameters constituting the multi-dimensional railway vehicle parameter. For example, the total step of DB class level for a feature value may be expressed as speed*power*railroad*temperature=10*10*5*5=2500.

In FIG. 8, the railway vehicle major component and system diagnosis apparatus 130 can determine a DB class level for a feature value using multi-dimensional railway vehicle parameters constituting the feature value, and can show the DB class level in a 2D coordinate system. It is possible to determine an average line, a σ-line (σ is a standard deviation), a 3σ-line, etc. that correspond to feature values at all levels under the assumption that distribution of a corresponding feature value follows Gaussian Distribution at each level on the basis of 2D distribution of the calculated feature value. The railway vehicle major component and system diagnosis apparatus 130 can define σ, 3σ, etc. as defection references and can use a σ-line, a 3σ-line, etc. as normal ranges for major components and systems.

The railway vehicle major component and system diagnosis apparatus 130 can determine a class level for a feature value using sensor values obtained from a plurality of sensors for each of major components and systems, and can construct and store a database of each of the major components and systems for the feature value and the class level in the database 150. The railway vehicle major component and system diagnosis apparatus 130 can determine an abnormal situation in major components and systems on the basis of the database for each of the major components and systems generated through the process described above, and can perform precise diagnosis on major components and systems of a railway vehicle.

Although the present disclosure was described above with reference to exemplary embodiments, it should be understood that the present disclosure may be changed and modified in various ways by those skilled in the art, without departing from the spirit and scope of the present disclosure described in claims.

The present disclosure can have the following effects. However, a specific embodiment is not intended to have to include all of the following effects or only the following effects, so the scope of a right of the present disclosure should not be construed as being limited by the embodiment.

The apparatus for diagnosing major components and a system of a railway vehicle according to an embodiment of the present disclosure can effectively detect abnormal situations in major components and a system by summarizing sensing values as parameters of multi-dimensional railway vehicles by classifying the sensing values in accordance with level sections respectively determined in advance for a plurality of sensors.

The apparatus for diagnosing major components and a system of a railway vehicle according to an embodiment of the present disclosure can effectively detect abnormal situations in major components and a system by calculating distribution in a 2D coordinate system by classifying each of a plurality of feature values accumulated through sampling into one of a plurality of class levels.

What is claimed is:

1. A railway vehicle major component and system diagnosis apparatus comprising:
a railway vehicle state summarizer that generates a feature value for at least one major component and system of a railway vehicle by summarizing sensing values collected through a plurality of sensors for a first period as a multi-dimensional railway vehicle parameter;
a database generator that generates a database for at least one major component and system of a railway vehicle by normally distributing a plurality of feature values accumulated for a second period composed of a plurality of continuous first periods; and
a railway vehicle diagnosis performer that detects and precisely diagnose abnormal situations in at least one major component and system of a railway vehicle on the basis of the database for major components and systems.

2. The apparatus of claim 1, wherein the railway vehicle state summarizer determines the first period to include sensing values for all of the plurality of sensors on the basis of a sensing cycle of each of the plurality of sensors.

3. The apparatus of claim 1, wherein the railway vehicle state summarizer grades sensing values in accordance with level sections defined in advance for the plurality of sensors and then summarizes the sensing values as the multi-dimensional railway vehicle parameter.

4. The apparatus of claim 1, wherein the database generator calculates distribution in a 2D coordinate system for feature values and class levels by classifying each of the plurality of feature values into one of a plurality of class levels.

5. The apparatus of claim 4, wherein the database generator sequentially classifies multi-dimensional railway vehicle parameters of the plurality of feature values in accordance with a classification order, thereby finally classifying the feature values into one of a plurality of class levels.

6. The apparatus of claim 1, wherein the railway vehicle diagnosis performer determines a normal range by applying detection references defined step by step respectively for the at least one major component and system of a railway vehicle.

7. The apparatus of claim 6, wherein the railway vehicle diagnosis performer performs real-time sampling with intervals of the first period for the at least one major component and system of a railway vehicle, and when a feature value generated through the sampling is out of the normal range and is continuously repeated by a reference number of times, the railway vehicle diagnosis performer detects it as an abnormal situation.

8. The apparatus of claim 1, wherein the railway vehicle diagnosis performer performs real-time sampling with intervals shorter then the interval of the first period for major components and systems of a railway vehicle from which the abnormal situation has been detected, and performs precise diagnosis on the basis of feature values generated through the sampling.
